(19) United States
(12) Patent Application Publication
(10) Pub. No.: US 2008/0190414 A1
(43) Pub. Date: Aug. 14, 2008

(54) Absorber for a Thermal Solar Collector and Method for the Production of Said Absorber

(76) Inventor: Andreas Link, Berlin (DE)

Correspondence Address: CASELLA & HESPOS, 274 MADISON AVENUE, NEW YORK, NY, 10016, US

(21) Appl. No.: 11/794,703

(22) PCT Filed: Dec. 21, 2005
(86) PCT No.: PCT/EP2005/014065

§ 371 Date: Jul. 3, 2007

(30) Foreign Application Priority Data
Jan. 7, 2005 (DE) 10 2005 001 435.6

(51) Int. Cl. F24J 2/24; B21D 53/02; B23K 26/24

(52) U.S. Cl. 126/651; 29/890.033; 219/121.64

(57) ABSTRACT

An absorber (1) is made available for a thermal solar collector comprising an absorber sheet (3) and at least one thermal fluid tube (5) that is connected in a thermally conducting fashion to the absorber sheet (3), has at least one bent section (2), and is connected to the absorber sheet (3) outside the bent section (2) via a continuous welded joint. The continuous welded joint (7, 8) is also present in the bent section (2) of the thermal fluid tube (5).

The present invention relates to an absorber for a thermal solar collector having an absorber sheet and at least one thermal fluid tube connected in a thermally conducting fashion to the sheet. The present invention also relates to a method for producing an absorber for a thermal solar collector.

A thermal solar collector absorbs the radiation of the sun and converts this into heat. The collected heat is transferred to a thermal fluid as transport means that transports the heat to its point of destination.

The core of a thermal solar collector is the absorber. This comprises a specifically coated sheet, and absorber sheet below, and at least one tube connected in a thermally conducting fashion to the sheet. When the sheet is heated because of insolation, the heat is passed on to the thermal fluid flowing through the tubes. A circulation of the thermal fluid can then be used, for example, to transport the heat into the heating circuit of a building, where it is finally released.

Various designs of thermal solar collectors and absorber sheets have been developed for different applications. The best known are flat collectors, vacuum collectors and solar absorbers.

In most absorbers, the thermal fluid tube is soldered or welded onto the absorber sheet. Plasma welding methods or laser welding methods, for example, are applied in order to weld the tube to the absorber sheet. EP0794032B1 describes a laser welding method in which a pulsed laser is used for welding. However, in alternative connection techniques the tube can also be clamped in a profile of the absorber sheet which is specifically shaped therefore, or be pressed into the absorber sheet. It is likewise possible to fold the absorber sheet around the tube.

The tubes guiding the thermal fluid can be arranged on the front side of the absorber sheet, facing the sun, or on its rear side, averted from the sun.

Particularly in the case of the connections, produced using welding methods, between the absorber sheet and the thermal fluid tubes, the aim is to improve the efficiency of the thermal solar collector and to improve the quality of the connection. However, the efficiency of the welding methods previously used to connect the absorber sheet to the thermal fluid tubes is very low.

With regard to the prior art, it is therefore an object of the present invention to make available an improved absorber for thermal solar collectors.

A further object of the present invention is to make available an improved method for producing an absorber for a thermal solar collector.

The first object is achieved by an absorber according to claim 1, and the second object is achieved by a method according to claim 8. The dependent claims contain further refinements of the absorber according to the invention and of the method according to the invention.

An inventive absorber for a thermal solar collector comprises an absorber sheet having at least one thermal fluid tube that is connected in a thermally conducting fashion to the absorber sheet, has at least one bent section, and is connected to the absorber sheet outside the bent section via a continuous welded joint. A continuous welded joint is also present in the bent section of the thermal fluid tube in the inventive absorber.

It is true that welded joints of thermal fluid tubes with an absorber sheet that have been produced continuously are already known, but in the case of these absorbers only straight tube sections are welded to the absorber sheet by means of a continuous welded joint. By contrast, bent tube sections have no welded joint with the absorber sheet. Furthermore EP 0 794 032 B1 discloses absorbers in which the thermal fluid tube is welded on using a pulsed welding method. These can certainly also have a welded joint in bent tube sections, but the welded joint is built up from weld points spaced apart from one another. In both cases, the transfer of heat from the sheet to the tube is not optimal.

Owing to the fact that the welded joint which is continuous in the inventive absorber is also present in bent regions of the tube there is an increase in the thermal contact area between sheet and tube, and this improves the transfer of heat. Moreover, the quality of the connection can be improved, since there is no need to interrupt the welding operation, it being possible for welded joints of poorer quality to arise upon applying and removing the welding set.

A collector performance that remains constant over decades can be ensured on the basis of the enlarged thermal contact area and the higher quality of the welded joint in the inventive absorber.

The inventive absorber can, in particular, have a meandering thermal fluid tube that is connected over its entire length to the absorber sheet by means of a continuous welded joint.

Such an absorber can, in particular, be produced in a single welding operation without removal of the welding set. This leads, on the one hand, to a time saving and, on the other hand, to an optimized mode of procedure during welding, since the welding set need not be removed and reapplied. This renders possible a reduction of costs of production, as well as production with a high throughput. Again, disadvantageous properties of the weld seam that can arise upon applying and removing the welding set can be avoided.

In one development of this refinement, the absorber is designed as an absorber strip. One absorber strip comprises an absorber sheet of a certain width with a thermal fluid tube fastened thereon, and can be produced in principle with any desired length. Since there is no need to apply and remove the welding set in the case of the inventive absorber, such an absorber strip can be produced in a continuous process, and this, in particular, enables a higher production throughput. However, the absorber can also be designed in the form of a whole area absorber, that is to say an absorber surface with specific dimensions.

In the inventive absorber, the weld seam of the welded joint can extend through the absorber sheet in the region of the contact line of the thermal fluid tube with the absorber sheet. Such a weld seam indicates the course of the thermal fluid tube even from the side of the absorber sheet averted from the thermal fluid tube. Furthermore the welding operation can be performed from the side of the absorber sheet averted from the thermal fluid tube, and this simplifies the production process.

In an alternative configuration, the weld seam can, however, also on the rear side, facing the thermal fluid tube, of the absorber sheet, be arranged in the region of the contact line of the thermal fluid tube with the absorber sheet, in the angle between the absorber sheet and the thermal fluid tube. In this configuration, the welded joint in particular produces a large contact surface between the absorber sheet and the thermal fluid tube, and this is particularly advantageous with regard to the heat transfer between sheet and tube, and thus with regard to the efficiency of the absorber. A particularly large contact surface can be attained when one weld seam each is arranged on each side of the contact line.

In the inventive absorber, the thermal fluid tube and/or the absorber sheet can, in particular, be produced from one of the following materials, or comprise one of the following materials: copper, aluminum, steel or stainless steel.

In the inventive method for producing an absorber for a thermal solar collector, a thermal fluid tube is welded onto an absorber sheet using continuous wave operation. A diode laser is used in this case for welding.

In comparison to the YAG (YAG: yttrium aluminum garnet) lasers for welding in methods according to the prior art, a diode laser has a reduced aperture area, and this leads to a reduced weld seam width. This is advantageous particularly when the tube is welded on from the front side, generally highly selectively coated, of the absorber, since less of the coating is impaired during the welding process. It follows that the useful surface of the coated side of the absorber sheet is enlarged in comparison to absorbers produced using methods according to the prior art.

In addition, by contrast with welding using a YAG laser, heat input into the absorber surface during welding with a diode laser is reduced. The reduction in the heat input particularly enables even bent tube sections to be welded to the absorber sheet using continuous wave operation. Consequently, the inventive method particularly enables the production of an inventive absorber.

By contrast, welding methods according to the prior art would bring about an excessively high input of heat into the absorber sheet in the bent section, and so would burn a hole into the sheet instead of bringing about a connection between the thermal fluid tube and the sheet.

Consequently, it has been proposed for the purpose of reducing the input of heat into the sheet to fasten the thermal fluid tube on the absorber sheet by means of a pulsed welding method instead of a continuous welding method.

However, a pulsed welding method does not produce a continuous weld seam, but merely weld points spaced apart from one another. Consequently, the thermally conducting contact between the absorber sheet and the thermal fluid tube is less for a tube that is welded on in a pulsed fashion than for a tube welded on in a continuous fashion.

In both cases, the transfer of heat from the absorber sheet to the thermal fluid tube is not optimal.

Disk diode lasers are particularly suitable for the inventive method, but it is also fundamentally possible to use rod diode lasers.

It is, in particular, possible to configure the method as a continuous wave welding method, since the inventive welding method can be used to weld both straight and bent tube sections onto an absorber sheet in a continuous fashion, and there is thus no need to remove the laser during welding. Such a method is particularly efficient.

In one configuration of the inventive method, during the welding energy of the diode laser is input into the surface of the absorber sheet that is averted from the coolant tube. In the case of an absorber produced using this configuration of the method, the course of the thermal fluid tubes is visible from the front side of the absorber sheet. This can be advantageous when mounting the absorber, for example.

In one alternative configuration of the inventive method, during welding the energy of the diode laser is input into the angle that is formed between the absorption sheet and the thermal fluid tube in the region of the contact line. The weld seam produced using this method then fills out the angle between the thermal fluid tube and the absorber sheet and leads to a particularly large contact area between the thermal fluid tube and absorber sheet.

The inventive welding method is particularly suitable for producing coherent bonds between a thermal fluid tube and an absorber sheet that are produced in each case from at least one of the following materials: copper, aluminum, steel or stainless steel.

In a particular configuration of the inventive method, the thermal fluid tube and/or the absorption sheet are under mechanical stress during welding. A particularly good welding result, and a particularly good durability of the product produced can be attained by means of a suitable mechanical stressing.

The welding operation can be optimized as follows: by selecting a suitable optical system and/or setting a suitable incidence angle and/or by setting a suitable focusing of the laser beam and/or by setting a suitable performance characteristic of the diode laser. The more the parameters are part of the optimization process, the better is the attainable optimization. Parameters are to be determined empirically as a function of the material to be welded and the geometry of the components.

Further features, properties and advantages of the present invention emerge from the following description of exemplary embodiments with reference to the attached figures, in which:

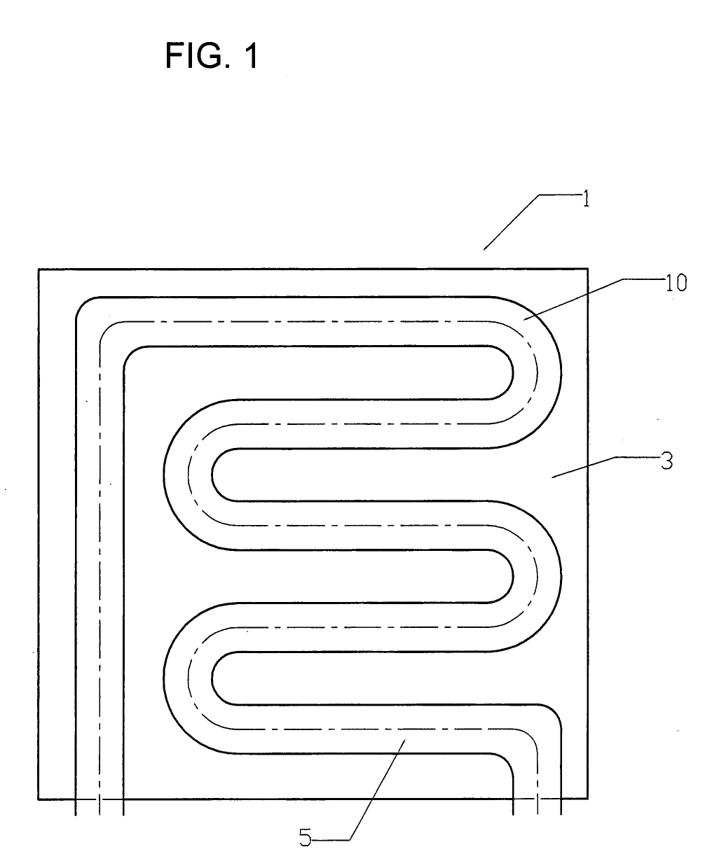

FIG. 1 shows the absorption sheet and the thermal fluid tube of a thermal solar collector in a schematic illustration.

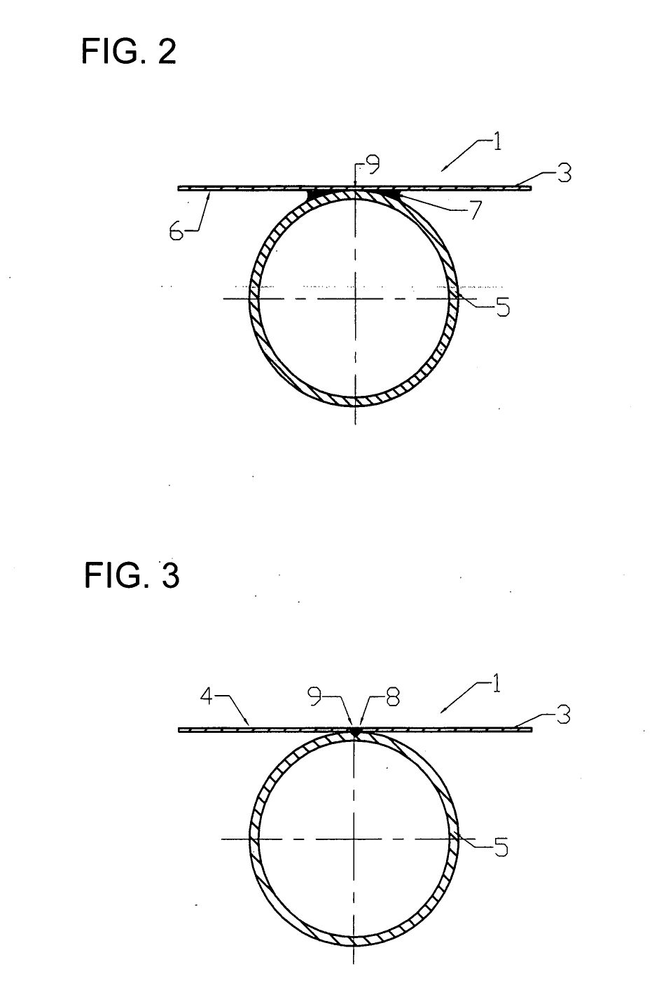

FIG. 2 shows a first exemplary embodiment of the continuous welded joint between the thermal fluid tube and the absorption sheet.

FIG. 3 shows a second exemplary embodiment of the continuous welded joint between the thermal fluid tube and the absorption sheet.

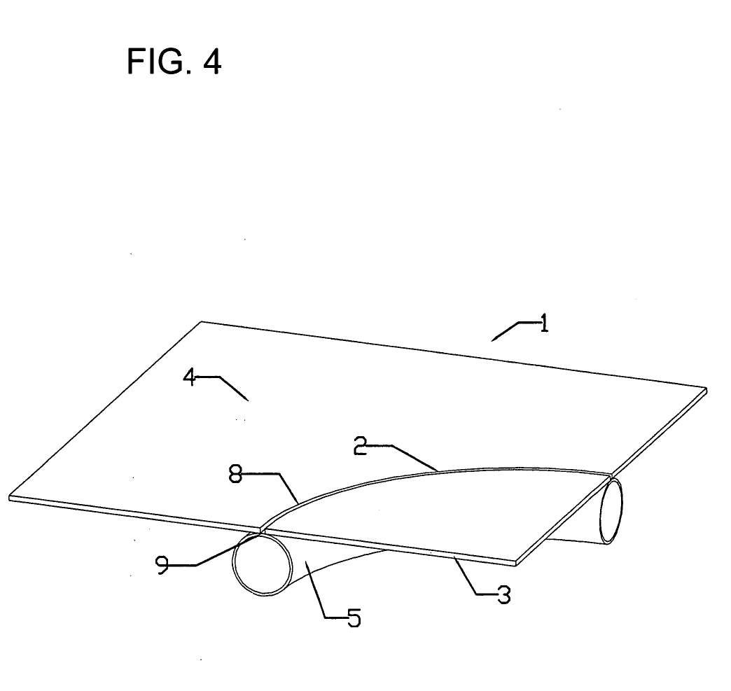

FIG. 4 shows a section from an absorption sheet with a thermal fluid tube welded thereon, in a perspective illustration.

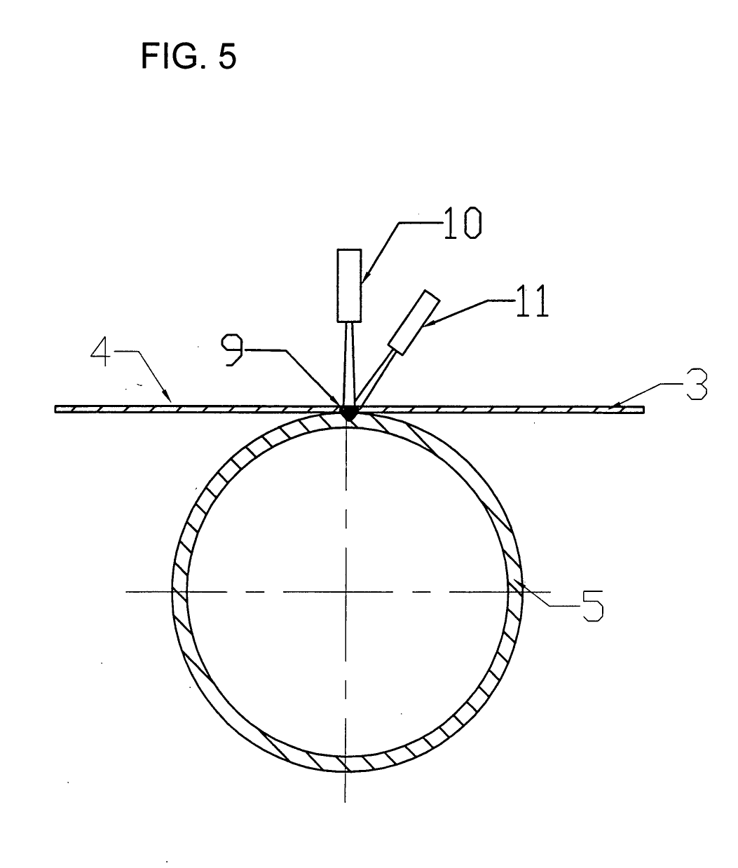

FIG. 5 shows a first example of welding the thermal fluid tube onto the absorber sheet.

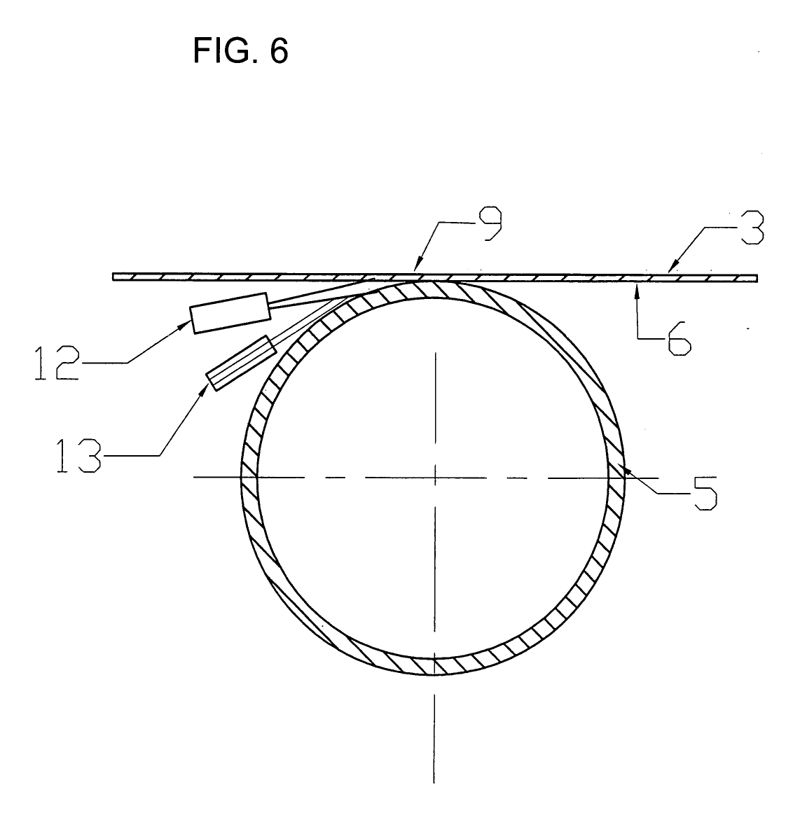

FIG. 6 shows a second example of the welding of the thermal fluid tube onto the absorber sheet.

An inventive absorber is shown in FIG. 1 in a greatly simplified illustration.

The absorber 1 comprises as essential components an absorber sheet 3 (illustrated by dashes in FIG. 1) with a meandering thermal fluid tube 5 welded thereon.

On its surface averted from the thermal fluid tube 5, the absorber sheet 3 has a highly selective coating that absorbs the radiant energy of the sun and converts it into heat. The heat is finally transported to a thermal fluid, for example water or a water/glycol mixture, that flows through the thermal fluid tube 5 and transports the heat to its destination.

The absorber sheet 3 and the thermal fluid tube 5 welded thereon are generally arranged in a protective housing that, at least in the region of the absorbing surface of the absorber sheet 3, is configured to be transparent in such a way that it allows the insolation to pass largely unhindered. The housing itself is not illustrated in FIG. 1, for the sake of clarity.

By way of example, copper sheet with copper tube, aluminum sheet with copper tube, aluminum sheet with stainless steel tube, etc are conceivable as material combinations for the absorber sheet and the thermal fluid tube. The materials should have a high thermal conductivity in this case. Typical sheet thicknesses are in the region of between 0.1 and 0.6 mm, and typical tube diameters lie between 5 and 15 mm.

The absorber 1 illustrated schematically in FIG. 1 is a so-called whole area absorber with a meander in the case of which the thermal fluid tube 5 has a number of bent sections 2 and is, for example, applied in medium to large numbers of items in the case of standardization. In addition, it can be designed with or without a manifold for the thermal fluid. The tube ends can have screw fittings or widenings in order to simplify connection to other tubes.

FIG. 2 shows a vertical section, running transverse to the tube longitudinal axis, through the absorber 1. The absorber sheet 3 and the thermal fluid tube 5 are to be seen. Also to be seen are the weld seams 7 via which the thermal fluid tube 5 is connected to the absorber sheet 3 by a coherent bond. These are arranged in the angle between the thermal fluid tube 5 and the absorber sheet 3 on the side of the contact line 9 of the thermal fluid tube with the absorber sheet 3. In this configuration of the absorber 1, the weld seams 7 produce a joint between the absorber sheet 3 and the thermal fluid tube 5 which is thermally conducting over a relatively large area, and this enables an effective heat transfer to the thermal fluid tube 5.

A second design variant of the weld seam in the inventive absorber 1 is illustrated in FIG. 3. Instead of being connected to the absorber sheet 3 by means of laterally arranged weld seams, the thermal fluid tube 5 is connected thereto by means of a weld seam 8 running along the contact line 9 of the thermal fluid tube with the absorber sheet 3 and extending through the absorber sheet 3. Such a weld seam 8 can be produced, in particular, from the coated side 4 of the absorber sheet 3.

Since the weld seam 8 of the second exemplary embodiment extends through the absorber sheet 3, the contact line 9—and thus the course of the tube—can be seen from the coated side 4 of the absorber sheet 3, and this can be advantageous in the case of mounting, for example. A section of an absorber 1 with a bent tube section 2 and a weld seam 8 which can be seen from the coated side 4 is illustrated, for example, in FIG. 4.

FIG. 5 illustrates schematically the welding in accordance with a first exemplary embodiment of the inventive method. In this first variant, the thermal fluid tube 5 and the absorber sheet 3 are welded to one another from the coated side 4 of the absorber sheet 3, that is to say the welding operation is performed through the absorber sheet 3. To this end, a diode laser 10 and a material feed 11 for feeding the filler metal to a contact point of the thermal fluid tube is aligned with the absorber sheet 3, and the laser 10 is then moved together with the material feed 11 using continuous wave operation along the axial direction of the thermal fluid tube 5.

Both a rod diode laser and a disk diode laser can be used as diode laser 10. In comparison to the use of a YAG laser, it is possible, in particular, to implement reduced weld seam widths when use is made of a disk diode laser. Since the surface coating of the absorber sheet 3 is removed in the region of the weld seam 8, the loss of absorption area can be reduced with the aid of a lesser weld seam width.

The use of a diode laser 10 enables thermal fluid tubes 5 to be welded onto the absorption sheet 3 not only in straight tube lengths, using continuous wave operation, but also in bent tube lengths. Consequently, the inventive method can be used, in particular, to weld meandering thermal fluid tubes 5 to the absorber sheet 3 without removing the laser using the continuous wave method.

The production time can be shortened, since in comparison to methods according to the prior art, in which bent tube lengths are not welded onto the absorber sheet in continuous wave laser welding, the entire tube can be welded onto the absorber sheet in one pass, that is to say without removing the laser and moving it to another site. This reduces the costs and enables industrial production in large batches. Welding rates of up to 50 m/min can be attained with the aid of the inventive method.

By suitably setting the parameterization of the optical system and/or the incidence angle and/or the focusing of the laser beam and/or the performance characteristic of the laser and/or the material feed during welding, it is possible to ensure when use is made of a diode laser that continuous wave welding can be performed even in the region of bent tube lengths without introducing holes or the like into the material and into the weld seam. This enhances the durability of the absorber even after many thermal stress reversals, and this lengthens the service life.

Furthermore, when the inventive method is applied there is an increase in the process reliability of the production in conjunction with a high throughput, and the reject rate can thus be reduced.

The thermal fluid tube 5, in particular, but also the absorber sheet 3, can be put under mechanical stress during welding. The mechanical stress can help to simplify the welding operation and to attain a weld seam of relatively high quality.

A second variant of the inventive method for producing an absorber 1 is illustrated in FIG. 6. This variant differs from the variant illustrated in FIG. 5 in that the welding of the thermal fluid tube 5 to the absorber sheet 3 is carried out from the tube side 6 of the sheet 3. In other words, both the diode laser 12 and the material feed 13 are located on the tube side in relation to the absorber sheet 3.

In this variant of the welding method, the weld seam is produced in the region of the contact line 9 along which the absorber sheet 3 is in contact with the thermal fluid tube 5, specifically in the angle between the absorber sheet 3 and the thermal fluid tube 5, as is illustrated in FIG. 2. If the aim is to produce a weld seam 7 on both sides of the contact line 9, this can be achieved by virtue of the fact that, firstly, the weld seam is produced on one side and, subsequently, the weld seam is produced on the other side. However, it is also possible alternatively to produce both weld seams simultaneously when using two diode lasers 12 and, optionally, two material feed devices 13.

However, it is also possible in principle to produce only one weld seam, that is to say merely one weld seam on one side of the contact line 9. However, because of the one-sided loading that occurs in this case it is preferred to produce two weld seams rather than produce one weld seam.

The second variant of the welding method can be used to attain substantially the same advantages as with the first variant. However, other than in the case of the first variant the second variant enables the coated surface of the absorber sheet 3 to be kept entirely free of weld seams, and this is advantageous with regard to optimizing surface that can be used to absorb the insolation.

In the case of the second variant of the welding method, as well, the thermal fluid tube 5, but also the absorption sheet 3, if appropriate, can be placed under mechanical stress during welding.

In both variants of the inventive method, ramping up can be performed before the continuous wave welding. The ramping up can prevent bringing about an excessively high energy potential of the laser beam when the diode laser is being moved up and moved away, which potential would be seen in that the material is thrown up on the surface in the region of the beginning and the end of the weld seam, and holes are possibly produced.

In both methods described, during welding filler metal is fed into the region in which the welded joint is to be produced. However, it is also possible as an alternative to weld without feeding filler metal. In such a welding process, the laser would remove material, which is then used to form the welded joint. For example, the laser beam could remove material at the thermal fluid tube, and the material removed from the thermal fluid tube could be deflected in the direction of the absorber sheet.

The method described also proves to be advantageous in producing absorber fins, that is to say absorbers or absorber elements that comprise a long narrow absorber sheet strip with a thermal fluid tube welded thereon, because of the only slight stressing of the absorber surface and the possible high welding rates. The inventive method is used to weld a straight tube mostly in the middle over its entire length on the long narrow absorber sheet. Either the first or the second variant of the method can be used for the welding on. However, instead of the straight tube it is also possible in principle to weld on a meandering tube.

The absorber fin can be assembled together with at least one further absorber fin to form a so-called strip or fin absorber in which at least two absorber fins are arranged next to one another. The thermal fluid tubes of the absorber fins then open respectively at both ends into a common distributor tube or manifold from which thermal fluid is distributed into the individual thermal fluid tubes or is collected from the individual thermal fluid tubes.

Instead of the absorber fin being used to build up a strip or fin absorber, it can also be employed to build up a vacuum absorber. To this end, the absorber fin is introduced into a glass tube that is subsequently sealed in a gastight fashion at both ends and evacuated. After being introduced into the glass tube, the ends of the thermal fluid tube project from the welded ends and are soldered into a distributor tube or manifold that is, for example, drilled. Given appropriate dimensions of the tube in relation to the dimension of the absorber fins, two or more absorber fins can be introduced next to one another into the tube.

1. Absorber (1) for a thermal solar collector, comprising an absorber sheet (3) having at least one thermal fluid tube (5) that is connected in a thermally conducting fashion to the absorber sheet (3), has at least one bent section (2), and is connected to the absorber sheet (3) outside the bent section (2) via a continuous welded joint, characterized in that the continuous welded joint (7, 8) is also present in the bent section (2) of the thermal fluid tube (5).

2. Absorber (1) according to claim 2, characterized in that present as thermal fluid tube (5) is a meandering thermal fluid tube that is connected over its entire length to the absorber sheet (3) by means of a continuous welded joint (7, 8).

3. Absorber (1) according to claim 2, characterized by its configuration as a whole area absorber or absorber strip.

4. Absorber (1) according to claim 1, characterized in that the weld seam (8) of the welded joint extends through the absorber sheet (3) in the region of the contact line (9) of the thermal fluid tube (5) with the absorber sheet (3).

5. Absorber (1) according to claim 1, characterized in that on the rear side (6), facing the thermal fluid tube (5), of the absorber sheet (3) the weld seam (7) is arranged in the angle between the thermal fluid tube (5) and the absorber sheet (3).

6. Absorber (1) according to claim 5, characterized in that one weld seam (7) each is arranged on each side of the contact line (9).

7. Absorber (1) according to claim 1, characterized in that the thermal fluid tube (5) and/or the absorber sheet (3) are/is produced from one of the following materials, or comprise one of the following materials: copper, aluminum, steel or stainless steel.

8. Method for producing an absorber (1) for a thermal solar collector according to claim 1, in which a thermal fluid tube (5) is welded onto an absorber sheet (3) using continuous wave operation, characterized in that a diode laser (10, 12) is used for welding.

9. Method according to claim 8, characterized in that a disk type diode laser (10, 12) is used.

10. Method according to claim 8, characterized in that the welding on is carried out using an endless method.

11. Method according to claim 8, characterized in that during the welding energy of the diode laser (10) is input into the surface (4) of the absorber sheet (3) that is averted from the coolant tube (5).

12. Method according to claim 8, characterized in that during welding the energy of the diode laser (12) is input into an angle formed between the absorber sheet (3) and the coolant tube (5).

13. Method according to claim 8, characterized in that the welding method produces a coherent bond between a thermal fluid tube (5) and an absorption sheet (3), which respectively consist of at least one of the following materials, or respectively comprise at least one of the following materials: copper, aluminum, steel or stainless steel.

14. Method according to claim 8, characterized in that the energy of the diode laser that is input into the material to be connected is optimized by selecting a suitable optical system and/or by setting a suitable incidence angle of the laser beam and/or by setting a suitable focusing and/or by setting a suitable performance characteristic of the diode laser.

15. Method according to claim 8, characterized in that the thermal fluid tube (5) and/or the absorber sheet (3) are/is under mechanical stress during welding.
